(19) United States
(12) Patent Application Publication
(10) Pub. No.: US 2014/0282186 A1
(43) Pub. Date: Sep. 18, 2014

(54) SYSTEM AND METHOD FOR FACILITATING ELECTRONIC TRANSACTIONS IN A FACILITIES MANAGEMENT COMPUTING ENVIRONMENT

(71) Applicant: FIRST SERVICE NETWORKS INC., Linthicum, MD (US)

(72) Inventors: Russell Joyner, Baltimore, MD (US); Clyde MOORE, Paradise Valley, AZ (US)

(73) Assignee: FIRST SERVICE NETWORKS INC., Linthicum, MD (US)

(21) Appl. No.: 13/838,193

(22) Filed: Mar. 15, 2013

(51) Int. Cl. G06F 3/0484

(52) U.S. Cl. CPC G06F 3/04842
USPC 715/771

(57) ABSTRACT

Methods and systems are provided for interactively identifying a replacement part from a list of parts by prompting a user to define product attributes. The method includes displaying a first data set on a mobile computing device; prompting a user of the mobile computing device to select a first attribute value from a first list of attribute values; applying the selected first attribute value to the first data set; generating a second data set comprising a subset of the first data set; displaying the second data set on the mobile computing device; prompting the user to select a second attribute value from a second list of attribute values; applying the selected second attribute value to the second data set; generating a final data set comprising a subset of the second data set; displaying the final data set on the mobile computing device; and prompting the user to select a unique entry from the final data set.

### TECHNICAL FIELD

The present invention herein generally relates to computer systems and applications for facilities management, and more particularly to a user interface and method for structuring pricing data for replacement parts.

### BACKGROUND

In the context of the present disclosure, facilities management broadly refers to the coordination of maintenance and repair activities for enterprises having multiple locations such as restaurants, shops, offices, hospitals, and virtually any other type of commercial, industrial, retail, or service site. In a typical scenario, a company specializing in third party facilities management, referred to herein as a facilities manager (FM), is contracted by the owner/operator of the business entity (the customer) to perform scheduled preventive maintenance (PM) services and non-scheduled repair services (also known as a service request or “SR”) for some or all of the customer's locations.

For non-scheduled service requests, the salient terms governing the contractual relationship between the FM and the customer typically include: i) the time elapsed from the initiation by the customer until a service technician arrives at the customer site (e.g., 4 hours); and ii) the total amount of time until the problem is fixed (e.g., 24 hours). These terms are often embodied in a service level agreement (SLA). In order to maintain a high level of customer satisfaction, the FM is incented to quickly dispatch a technician upon receipt of a request for service, and to complete the repair in a timely and cost efficient manner.

In order to accomplish these objectives, the FM may operate one or more service centers through which the FM coordinates selecting and assigning a technician to each PM and SR activity. A particular technician, in turn, may be employed by the FM or, alternatively, the FM may contract with a local contracting company to provide service technicians and an inventory of replacement parts. Presently known systems for managing the daily operations of a state of the art FM service center include the FUSION™ software system developed for First Service Networks, Inc. of Linthicum, Md., a leader in the field of multi-site maintenance and repair services. Information pertaining to the FUSION™ system may be found at www.firstservicenetworks.com.

The key terms governing the contractual relationship between the FM and the contractor include the technician's hourly rate and the cost for replacement parts used in connection with the maintenance and service activities. In most cases, the technician's hourly rate is agreed to in advance for the term of the contract between the FM and the contractor. Thus, the key variable subject to scrutiny often surrounds the cost of replacement parts. Presently known systems for automatically managing repair and maintenance costs are described in U.S. Pat. No. 7,685,076 B2 entitled “Online Reduction in Repair and Maintenance Costs” issued Mar. 23, 2010 and commonly assigned herewith.

Mature and robust systems have been developed for generating an electronic invoice from the contractor to the FM to cover the technician's time and the cost of the replacement parts. These systems, however, are limited in their ability to allow an on-site technician to retrieve and quickly enter replacement part information into the contractor's central computer, and to generate an electronic invoice from the contractor to the FM which includes pricing information for the replacement parts.

### SUMMARY OF THE INVENTION

In accordance with one embodiment of the present invention, a systems and methods are provided for storing and retrieving data for large numbers of replacement parts across a wide range of facilities management product and service lines, and for presenting the replacement parts information to an on-site technician in an efficient and intuitive manner.

### BRIEF DESCRIPTION OF THE DRAWING FIGURES

A more complete understanding of the subject matter may be derived by referring to the detailed description and claims when considered in conjunction with the following figures, wherein like reference numbers refer to similar elements throughout the figures, and:

FIG. 1 is a schematic block diagram of a relationship map involving a facilities management company, a contractor, a customer site, and a customer corporate headquarters in accordance with an embodiment;

FIG. 2 is a schematic block diagram of a facilities management computing environment in accordance with an embodiment;

FIG. 3 is a flow diagram of a process for identifying a replacement part within a predetermined price range by a field technician in accordance with an embodiment;

FIGS. 4-10 are exemplary screenshots representing the interactive user interface presented by the system onto the technician's tablet in accordance with various embodiments;

FIG. 11 is a schematic block diagram graphically illustrating product attributes applied to successively smaller subsets of data in accordance with an embodiment; and

FIG. 12 is a flow chart illustrating an exemplary method for interactively selecting a replacement part by prompting a user to define product attributes, in accordance with an embodiment.

### DETAILED DESCRIPTION OF PREFERRED EXEMPLARY EMBODIMENTS

Embodiments of the subject matter described herein generally relate to systems and methods for structuring data relating to replacement parts in a facilities management system, and more particularly to data structures which define a plurality of attributes associated with each of a variety of component parts.

In various embodiments, the systems and methods described herein may be implemented in computer code stored on or embodied in a computer readable medium such as a hard drive, removable drive, or network server, and the system includes an interactive user interface displayed on a mobile computing device such as a tablet.

Turning now to FIG. 1, a relationship map 100 includes a facilities management company (also referred to as the facilities manager (FM)) 102, a contractor 104, a customer site 106, and a customer headquarters (customer HQ) 108. In a typical scenario, a customer 108, such as a restaurant, coffee shop, hospital, office, or any other type of commercial or industrial retail or service business has a plurality of associated customer sites 106 (only one such customer site 106 is shown in FIG. 1 for clarity). Due to the complex nature or facilities management involving the repair and maintenance of plumbing, electrical apparatus, heating, ventilation, and air conditioning (HVAC) systems, and the like, and further due to the geographically dispersed nature of multi-site customer organizations, many customers contract with an FM to coordinate their maintenance and repair functions under a service level agreement (SLA).

When a scheduled preventive maintenance (PM) task or a non-scheduled service request (SR) requires attention, the FM 102 dispatches a service technician to the appropriate customer site 106. In a typical scenario, the manager on duty at the customer site reports an equipment failure or other service request to the FM 102 via an alert communication indicated by broken arrow 110. The alert communication 110 may be in the form of an email, telephone call, text message, or any convenient communication modality. In response to communication 110, the FM 102 transmits a service request (SR) communication (indicated by broken arrow 112) to the contractor 104, advising the contractor 104 of the nature of the problem, the location of the customer site 106, and the expected cost of the service call, expressed as an amount “not to exceed” (NTE). Upon receipt of the SR communication 112, the contractor 104 dispatches a service technician (not shown in FIG. 1) to the customer site 106, indicated by broken arrow 114.

After the technician repairs the equipment or otherwise completes the work order at the customer site 106, the technician generates an electronic work ticket identifying the component parts replaced at the work site during the repair, and submits an electronic work ticket evidencing completion of the service call to the contractor HQ 104. The contractor 104 then converts the work ticket to an invoice, and submits an electronic invoice to the FM 102 for payment.

Referring now to FIG. 2, an exemplary facilities management computing environment 200 includes a server 202 that supports applications 228 for facilitating, inter alia, the rendering of electronic work tickets and electronic invoices, and presents interactive user interface screens 222 to the technician. The applications 228 are configured to access product data 232 from a virtual inventory database 230, also referred to as a replacement parts database designed to approximate the universe of possible replacement parts used by the various contractors under contract with the FM 102.

Data, user interface screens, and templates utilized by the applications 228 may be provided via a network 245, such as a cloud computing environment, to any number of nodes or devices configured to interact with the network 245. Exemplary nodes may include: i) a tablet computer or other mobile device 240 operated by the technician; ii) a computer (e.g., a desktop computer) 242 located at the contractor HQ; iii) a device 244 (e.g., a mobile or land line telephone, laptop, desktop, or tablet computer) located at the customer site 106 or otherwise used by the manager of the customer site; iv) a computer 246 located at and/or used by a customer service representative associated with the FM 102; and v) a computer 248 located at or otherwise associated with the customer HQ.

The database 230 may be implemented using conventional database server hardware. In various embodiments, the database 230 shares processing hardware with the server 202 including input/output (I/O) hardware 207, a processor 205, and memory 206. In other embodiments, the database 230 may be implemented using separate physical and/or virtual database server hardware that communicates with the server 202 to perform the various functions described herein. In an exemplary embodiment, the database 230 includes a database management system or other equivalent software capable of retrieving and providing defined subsets of the data 132 128 in response to a query initiated or otherwise provided by an application 128, as described in greater detail below.

In practice, the data 232 may be organized and formatted in any manner to support the applications 228. In various embodiments, the data 132 is suitably organized into product categories, with each data entry having one or more attributes. The data 232 can then be organized as needed for a particular application. In various embodiments, conventional data relationships are established using indexing, uniqueness, relationships between entities, and/or other aspects of conventional database organization, as desired.

The server 202 operates with any sort of conventional processing hardware. The input/output features 207 generally represent the interface(s) to networks (e.g., to the network 245, or any other local area, wide area or other network), mass storage, display devices, data entry devices and/or the like.

The processor 205 may be implemented using any suitable operating system 209 or processing system, such as one or more processors, controllers, microprocessors, microcontrollers, processing cores and/or other computing resources spread across any number of distributed or integrated systems, including any number of “cloud-based” or other virtual systems. The memory 206 represents any non-transitory short or long term storage or other computer-readable media capable of storing programming instructions for execution on the processor 205, including any sort of random access memory (RAM), read only memory (ROM), flash memory, magnetic or optical mass storage, and/or the like. The computer-executable programming instructions, when read and executed by the server 202 and/or processor 205, cause the server 202 and/or processor 205 to create, generate, or otherwise facilitate the applications 228 and perform one or more additional tasks, operations, functions, and/or processes described herein. It should be noted that the memory 206 represents one suitable implementation of such computer-readable media, and alternatively or additionally, the server 202 could receive and cooperate with external computer-readable media that is realized as a portable or mobile component or platform, e.g., a portable hard drive, a USB flash drive, an optical disc, or the like.

With continued reference to FIG. 2, the data processing engine 260 performs bulk processing operations on the data 232 such as uploads or downloads, search queries, and the rendering of various forms and templates such as work ticket, electronic invoices, and the like. In exemplary embodiments, the applications 228 may make use of interface features such as user interface screens 222.

The various computing devices that interface with the cloud 245 may employ a conventional browser application to contact the server 202, using a networking protocol such as the hypertext transport protocol (HTTP) or the like. The application 228 may contain Java, ActiveX, or other content that can be presented using conventional client software running on the client device (e.g., tablet 240); other embodiments may simply provide dynamic web or other content that can be presented and viewed by the user, as desired. As described in greater detail below, the data processing engine 260 suitably obtains the requested data 232 from the database 230 as needed to populate the work tickets or other features of the particular application 228.

In accordance with various embodiments, application 228 may be an interactive application for assisting the technician in creating an electronic work ticket for a completed service request, and for assisting the contractor HQ 104 in converting a work ticket into an electronic invoice for submission to the FM 102, as described in greater detail below. To facilitate the ensuing discussion, reference is made to the exemplary screen shots illustrated in FIGS. 4-10.

With momentary reference to FIG. 3, a flow diagram of a process 300 for identifying a replacement part within a predetermined price range by a field technician is shown. More particularly, process 300 involves advising a technician as to the nature and location of the service request (SR) (Task 302). The technician is then dispatched to the job site, notifies the system upon arrival, and completes the repairs (Task 304).

Process 300 continues by prompting the technician to define the scope of work performed (Task 306), and prompting the technician to identify the replacement part(s) used in performing the work (Task 308). The system then generates an electronic work ticket (Task 310) which summarizes the work performed and the replacement parts used, and the work ticked is executed (signed) by both the technician and the customer (Task 312).

Referring now to FIGS. 4-10, process 300 is implemented through an interactive user interface presented to the technician on a mobile computing device such as a tablet computer. The interactive user interface, in turn, includes a series of screenshots which prompt the technician to point and click on a touch screen, type in data, and perform various other interactive functions.

More particularly, FIG. 4 shows an exemplary screenshot 400 for prompting the technician to select and/or identify a particular SR. Screenshot 400 includes a field 406 for typing in a particular SR number, if known, and a lookup virtual button 404 for retrieving the SR entered into the field 406. If the SR number is not known, the technician may touch (and thereby select) a job list virtual button 402 to reveal a list of open SRs potentially available to the technician, as shown in FIG. 5.

Upon pressing the job list button 402 in FIG. 4, a list 502 of pending SRs is presented to the technician, as shown in FIG. 5. In the illustrated example, job list 502 includes four (4) open jobs 504, 506, 508, and 510. To facilitate this discussion, suppose the technician selects job 506 for example.

FIG. 6 shows an exemplary screenshot 600 detailing job 506 from FIG. 5. In particular, screenshot 600 displays job details 602 including a unique SR identifier 604, the site address and telephone phone number 606, and the line of service (LOS) 608. In the illustrated example, the LOS is heating ventilation and air conditioning (HVAC). Other possible lines of service include plumbing, upholstery, electrical, flooring, and so on.

Job details 602 further include the dollar amount by which the job is not to exceed (NTE) 608, the job priority (e.g., high, medium, low) 610, the job status 612, the job type 614 (e.g., PM or SR), a description 616 of the equipment to be serviced, the estimated time of arrival (ETA) of the technician on the job site, and the time in 620, which corresponds to the time the service request was called into the FM by the customer.

With continued reference to FIG. 6, screenshot 600 further includes a work description section 622 which includes a list of tasks to be checked off by the technician as (and if) performed. When the work is complete, the technician may simply select the work complete virtual button 626 if no components have been installed or replaced. In the more typical situation in which parts are installed, the technician will select the “add work performed” virtual button 624 to initiate the process of identifying the installed parts.

FIG. 7 presents a screenshot 700 which prompts the technician to enter information for installed hardware. In particular, screenshot 700 includes an asset field 702 and an action performed field 704, each having an associated drop down menu. The asset field 702 corresponds to the particular piece of equipment located at the job site which was worked on, and the action performed field defines the nature of the work. In the illustrated example, the selected asset is an air conditioner manufactured by Carrier™ having product code 01/0204F10658/38AR0014-601/Carrier. The action performed is “replace”, having been selected by the technician from a drop down menu which includes other options such as repair, lubricate, calibrate, and the like.

Having selected “replace” for the work performed, the system presents the technician with another drop down menu (not shown) which includes all the components associated with the selected asset which could have been replaced. The list of replaceable components for the selected asset (the Carrier air conditioner) includes a compressor, coil, fan motor, and the like. In this example, the technician has replaced the compressor. Referring now to FIG. 8, a screenshot 800 includes an asset field 802, an action performed field 804 (corresponding to fields 702 and 704 of FIG. 7, respectively), a category field 806, and a component part list 808 including respective component part entries 808(a), 808(b) . . . 808(n). In the illustrated example, selecting the category “Compressor—Medium Temp” causes part list 808 to be displayed, including (in this example) six (6) pages of component parts 808(a)-808(n), each having seven (7) characteristics. By way of example, entry 808(a) (“Comp MT 0.25 Ton Herm Recip P1 Gen Replacement”) is defined by the following characteristics:

| Parameter | Value |
|---|---|
| 1) Category | Compressor |
| 2) Temperature | Medium (MT) |
| 3) Tonnage | 0.25 Ton |
| 4) Seal Type | Hermetic (Herm) |
| 5) Motor Type | Reciprocating (Recip) |
| 6) Phase | 1 (P1) |
| 7) OEM/Generic | Generic (Gen Replacement) |

FIG. 9 shows a screenshot 900 having a replacement part field 902 and a task list 904. More particularly, by selecting the component part “Comp MT 5 Ton Herm Recip P1 Gen Replacement” from the list 808 in FIG. 8, the system displays that part in part field 902 (FIG. 9), and also presents the technician with a list of tasks/additional sub-components known to be associated with the selected component part. The technician then enters the quantity (typically 1) of sub-components used in the “Qty” box proximate each sub-component, and clicks the “Next” virtual button 906.

Having successfully entered into the system the component part(s) used for this particular service request (or preventive maintenance task), the system generates and presents the technician with an electronic work ticket, as shown in screenshot 1000 in FIG. 10. In the illustrated example, the work ticket includes a work location summary 1002, a service request detail summary 1004, a parts list 1006, a technician signature virtual button 1008, and a customer signature virtual button 1010. At this juncture, the technician's work is complete, and the work ticket is stored for subsequent conversion to an electronic invoice by the contractor HQ 104.

More particularly, the contractor HQ 104 converts the work ticket into an invoice and submits the invoice to the FM 102 for payment. A key factor in this conversion involves setting forth the prices charged by the contractor for the replacement parts. If the price requested by the contractor is higher than the contractor is willing to pay, the two parties typically negotiate a compromise. However, this process consumes administrative resources and causes delay. It is therefore in both parties' interest to structure replacement parts lists in a way that i) minimizes price variation within a group of similarly defined parts, and ii) facilitates the interactive selection of the replaced part from the list by the technician in the field. Accordingly, in an alternate embodiment, the parts lists may be structured by defining sub-classes of similar parts according to predetermined attributes, as described in greater detail below in conjunction with FIGS. 11 and 12.

FIG. 11 is a schematic block diagram 1100 which graphically illustrates product attributes being applied to successively smaller subsets of data in accordance with an alternate embodiment of the invention. More particularly, a first data set 1102 may include all parts belonging to a particular designation, such as a product category. Exemplary product categories may include compressors, fan motors, and so on. As such, if the first data set 1102 includes, for example, all medium temperature compressors, the data set might resemble the parts list 808 shown in FIG. 10.

With continued reference to FIG. 11, a first attribute 1110 is applied to the first data set 1102 to produce a resulting second data set 1104 (which is a subset of the first data set 1102). If desired, a second attribute 1112 may be applied to the second data set 1104 to thereby generate a third data set 1106 (which is a subset of the second data set 1104). The process of recursively applying subsequent attributes to successively smaller subsets of continues until a final data subset 1108. The particular attributes used, and the number of attributes applied, are suitably designed to drive the final data subset to a reasonable and manageable number of data entries presented to the technician for final selection. In an embodiment, the number of unique data entries in the final data set 1108 is in the range of 2-20, and preferably about 3-5.

With continued reference to FIG. 11, each attribute 1110, 112, 1114 may be configured to substantially reduce the number of entries from the previous data subset. For example, if the first data set 1102 includes all medium temperature compressors, the first attribute 1110 may be “Tonnage”, in which case the technician is presented with the available tonnage options, such as “0.25”, “0.33”, “0.5”, “1”, “2”, “5,”, and the like. If the technician selects “0.25”, then the next data subset 1104 will include only 0.25 ton medium temperature compressors. If the second attribute 1112 is, for example, “Seal Type”, and the technician selects “Herm”, then the next data subset 1106 will include only 0.25 ton medium temperature hermetically sealed compressors.

If the number of entries in the then current data subset is deemed too large to conveniently present to the technician in an efficient, user friendly manner, the system prompts the user with a third attribute 1114, for example, “Motor Type”. By selecting “P1”, the next data subset will include only single phase, 0.25 ton, medium temperature, hermetically sealed compressors.

FIG. 12 is a flow chart illustrating an exemplary method for interactively selecting a replacement part by prompting a user to define product attributes, in accordance with an embodiment. More particularly, method 1200 involves displaying (Task 1202) a first data set including a list of parts belonging to a particular category, such as medium temperature compressors. Method 1200 further includes prompting the user (Task 1204) to select a first attribute value and apply that value as an argument to the first data set. That is, the technician is presented with several values defining a particular characteristic or parameter associated with the parts list to thereby reduce the then current list to a smaller, more easily manageable number of parts.

In the example discussed above in connection with FIGS. 4-11, task 1204 might entail presenting the technician with several values defining the parameter “tonnage”, such as the values “0.25”, “0.33”, “0.5”, and so on. When the technician selects the appropriate value which best characterizes the component installed at the job site (e.g., “0.25”), this value is applied as an argument to the then current data set, to yield a subset of data comprising only those entries which satisfy the argument, i.e., only those medium temperature compressors which are also characterized as 0.25 ton.

Method 1200 further involves displaying (Task 1206) the second data set, for example in the context of the user interface used by the technician on his or her tablet computer. If the then current number of candidate component parts is within a reasonable range (e.g., 3-5), the technician may simply point-and-click and thereby select the listed component which nest matches the installed part. If, on the other hand, the then current list is greater than 3-5 entries (or any other desired number), the system may present the technician with one or more additional attributes to narrow the list down to a more easily manageable number.

Method 1200 further includes prompting the user (Task 1208) to select a second attribute value and apply that value as an argument to the second data set. In the current example, task 1208 might entail prompting the technician to define an additional attribute, such as “seal type”, “motor type”, or “phase”. The process of recursively reducing the data set by applying successive attribute values to the then current data set continues until the list of candidate parts is reduced to an acceptable number.

Method 1200 then displays (Task 1210) this final data set (parts list) on the technician's tablet. The technician then selects (Task 1212) the replaced part from the final list.

Reducing the number of parts on the list through the use of attributes allows the technician to point-and-click through a series of menus having a small number of attribute values to choose from (e.g., “low”, “medium”, “hi”). This avoids the cumbersome and error-prone process of scrolling through long lists of data, or jumping from page-to-page to find the correct part on a long list. Moreover, by carefully configuring the attributes for each product category, price variation within a finally selected part entry may be minimized, for example, in the range of 5-10%.

The foregoing description is merely illustrative in nature and is not intended to limit the embodiments of the subject matter or the application and uses of such embodiments. Furthermore, there is no intention to be bound by any expressed or implied theory presented in the technical field, background, or the detailed description. As used herein, the word “exemplary” means “serving as an example, instance, or illustration.” Any implementation described herein as exemplary is not necessarily to be construed as preferred or advantageous over other implementations, and the exemplary embodiments described herein are not intended to limit the scope or applicability of the subject matter in any way.

For the sake of brevity, conventional techniques related to computer programming, computer networking, database querying, database statistics, query plan generation, XML and other functional aspects of the systems (and the individual operating components of the systems) may not be described in detail herein. In addition, those skilled in the art will appreciate that embodiments may be practiced in conjunction with any number of system and/or network architectures, data transmission protocols, and device configurations, and that the system described herein is merely one suitable example. Furthermore, certain terminology may be used herein for the purpose of reference only, and thus is not intended to be limiting. For example, the terms “first”, “second” and other such numerical terms do not imply a sequence or order unless clearly indicated by the context.

Embodiments of the subject matter may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In this regard, it should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices. In this regard, the subject matter described herein can be implemented in the context of any computer-implemented system and/or in connection with two or more separate and distinct computer-implemented systems that cooperate and communicate with one another.

A method is thus provided for interactively identifying a replacement part from a list of parts by prompting a user to define product attributes. In an embodiment, the method includes: displaying a first data set, namely, the list of parts; prompting the user to select a first attribute value; applying the selected first attribute value to the first data set; displaying a second data set comprising a subset of the first data set; prompting the user to select a second attribute value; applying the selected second attribute value to the second data set; displaying a final data set comprising a subset of the second data set; and prompting the user to select a unique replacement part from the final data set.

In an embodiment, the step of displaying comprises presenting a graphical user interface on a mobile computing device such as a tablet computer.

In a further embodiment, the first data set corresponds to a list of parts for one of the following product categories: heating ventilation and air conditioning (HVAC); plumbing; electrical; flooring; lighting; brewing; coffee; and upholstery.

In one embodiment, the first data set comprises a list of medium temperature HVAC compressors, and the first and second attributes comprise one of: temperature; tonnage; seal type; motor type; phase; and OEM/generic. Moreover, where one of the first and second attributes comprises tonnage, the corresponding tonnage attribute values may include: 0.33; 0.25; 0.5; 1; 1.5; and 5.

In an embodiment wherein one of the first and second attributes comprises seal type, the corresponding seal type attribute values include hermetic and non-hermetic.

In a further embodiment, the step of applying comprises applying an attribute value as an argument to a data set to thereby generate a data subset which includes only those entries in the original data set having the applied attribute value.

In another embodiment, the method further includes prompting the user to select and additional attribute value, and applying the selected additional attribute value to the then current data set. The final data set may comprises a number of data entries in the range of two to twenty, and preferably in the range of three to five.

A method is also provided for facilitating electronic transactions in a facilities management computing environment of the type including a facilities manager (FM) node, a contractor headquarters (HQ) node, a mobile computing node, a customer site node, a customer HQ node, and a network having a processor. The method involves the steps of: transmitting, via the network, a service request (SR) alert from the customer site node to the FM node; dispatching, via the network, the mobile computing node to a job site associated with the customer site node to perform a repair task; generating an electronic work ticket identifying a component part replaced at the job site during the repair task; transmitting, via the network, the electronic work ticket from the mobile computing node to the contractor HQ node; converting the electronic work ticket to an electronic invoice; and transmitting, via the network, the electronic invoice from the contractor HQ node to the FM node for payment; wherein identifying the component part comprises displaying a list of parts at the mobile computing node, repeatedly applying an attribute value to successive subsets of the list of parts, and prompting a technician to select a unique entry from a final data set displayed on the mobile computing node.

In an embodiment, the mobile computing node comprises a tablet computer, and the step of repeatedly applying an attribute value comprises prompting the user to select a first attribute value from a menu of attribute values.

In a further embodiment, the step of repeatedly applying comprises applying an attribute value as an argument to a data set to thereby generate a data subset which includes only those entries in the original data set having the applied attribute value.

In an embodiment, the list of parts comprises one of the following product categories: heating ventilation and air conditioning (HVAC); plumbing; electrical; flooring; lighting; brewing; coffee; and upholstery.

In another embodiment, the list of parts comprises a list of medium temperature HVAC compressors, and the attribute comprises one of: temperature; tonnage; seal type; motor type; phase; and OEM/generic.

Also provided is a computer application embodied in a non-transitory medium for operation by a one or more computer processors for performing the steps of: displaying a first data set on a mobile computing device, the first data set comprising the list of parts; prompting a user of the mobile computing device to select a first attribute value from a first list of attribute values; applying the selected first attribute value to the first data set; generating a second data set comprising a subset of the first data set; displaying the second data set on the mobile computing device; prompting the user to select a second attribute value from a second list of attribute values; applying the selected second attribute value to the second data set; generating a final data set comprising a subset of the second data set; displaying the final data set on the mobile computing device; and prompting the user to select a unique entry from the final data set.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application. Accordingly, details of the exemplary embodiments or other limitations described above should not be read into the claims absent a clear intention to the contrary.

What is claimed is:

1. A method for interactively identifying a replacement part from a list of parts by prompting a user to define product attributes, the method comprising:
displaying a first data set comprising the list of parts;
prompting the user to select a first attribute value;
applying the selected first attribute value to the first data set;
displaying a second data set comprising a subset of the first data set;
prompting the user to select a second attribute value;
applying the selected second attribute value to the second data set;
displaying a final data set comprising a subset of the second data set; and
prompting the user to select a unique replacement part from the final data set.

2. The method of claim 1, wherein displaying comprises presenting a graphical user interface on a mobile computing device.

3. The method of claim 2, wherein the mobile computing device comprises a tablet computer.

4. The method of claim 1, wherein the first data set comprises a list of parts corresponding to one of the following product categories: heating ventilation and air conditioning (HVAC); plumbing; electrical; flooring; lighting; brewing; coffee; and upholstery.

5. The method of claim 1, wherein the first data set comprises a list of medium temperature HVAC compressors.

6. The method of claim 5, wherein the first and second attributes comprise one of: temperature; tonnage; seal type; motor type; phase; and OEM/generic.

7. The method of claim 5, wherein one of the first and second attributes comprises tonnage, and the corresponding tonnage attribute values include: 0.33; 0.25; 0.5; 1; 1.5; and 5.

8. The method of claim 7, wherein one of the first and second attributes comprises seal type, and the corresponding seal type attribute values include: hermetic; and non-hermetic.

9. The method of claim 1, wherein applying comprises applying an attribute value as an argument to a data set to thereby generate a data subset which includes only those entries in the original data set having the applied attribute value.

10. The method of claim 1, further comprising:
prompting the user to select and additional attribute value; and
applying the selected additional attribute value to the then current data set.

11. The method of claim 1, wherein the final data set comprises a number of data entries in the range of two to twenty.

12. The method of claim 1, wherein the final data set comprises a number of data entries in the range of three to five.

13. A method for facilitating electronic transactions in a facilities management computing environment including a facilities manager (FM) node, a contractor headquarters (HQ) node, a mobile computing node, a customer site node, a customer HQ node, and a network having a processor, the method comprising the steps of:
transmitting, via the network, a service request (SR) alert from the customer site node to the FM node;
dispatching, via the network, the mobile computing node to a job site associated with the customer site node to perform a repair task;
generating an electronic work ticket identifying a component part replaced at the job site during the repair task;
transmitting, via the network, the electronic work ticket from the mobile computing node to the contractor HQ node;
converting the electronic work ticket to an electronic invoice; and
transmitting, via the network, the electronic invoice from the contractor HQ node to the FM node for payment;
wherein identifying the component part comprises displaying a list of parts at the mobile computing node, repeatedly applying an attribute value to successive subsets of the list of parts, and prompting a technician to select a unique entry from a final data set displayed on the mobile computing node.

14. The method of claim 13, wherein the mobile computing node comprises a tablet computer.

15. The method of claim 13, wherein repeatedly applying an attribute value comprises prompting the user to select a first attribute value from a menu of attribute values.

16. The method of claim 13, wherein repeatedly applying comprises applying an attribute value as an argument to a data set to thereby generate a data subset which includes only those entries in the original data set having the applied attribute value.

17. The method of claim 13, wherein the list of parts comprises one of the following product categories: heating ventilation and air conditioning (HVAC); plumbing; electrical; flooring; lighting; brewing; coffee; and upholstery.

18. The method of claim 13, wherein the list of parts comprises a list of medium temperature HVAC compressors, and the attribute comprises one of: temperature; tonnage; seal type; motor type; phase; and OEM/generic.

19. The method of claim 13, wherein the final data set comprises a number of data entries in the range of three to five.

20. A computer application embodied in a non-transitory medium for operation by a one or more computer processors for performing the steps of:
displaying a first data set on a mobile computing device, the first data set comprising the list of parts;
prompting a user of the mobile computing device to select a first attribute value from a first list of attribute values;
applying the selected first attribute value to the first data set;
generating a second data set comprising a subset of the first data set;
displaying the second data set on the mobile computing device;
prompting the user to select a second attribute value from a second list of attribute values;
applying the selected second attribute value to the second data set;
generating a final data set comprising a subset of the second data set;
displaying the final data set on the mobile computing device; and
prompting the user to select a unique entry from the final data set.
